(19) United States
(12) Patent Application Publication
(10) Pub. No.: US 2002/0119208 A1
(43) Pub. Date: Aug. 29, 2002

(54) Soy phytochemical composition

(76) Inventor: Daniel Chajuss, M.P. Emek Sorek (IL)

Correspondence Address: Daniel H. Shulman, MAYER, BROWN & PLATT, P.O. Box 2828, Chicago, IL, 60690-2828, US

(21) Appl. No.: 09/767,429

(22) Filed: Jan. 22, 2001

(30) Foreign Application Priority Data
Dec. 14, 2000 (IL) 140297

(51) Int. Cl. A61K 35/78

(52) U.S. Cl. 424/757; 514/27

(57) ABSTRACT

Disclosed is a soy phytochemical composition obtained by removing soluble components out of acidified soy molasses by settling, decantation and/or centrifugation to obtain a precipitated residue sediment containing not less than 6% of isoflavones, 18% of saponins and 13% of crude low molecular weight protein material on a dry matter basis.

### BACKGROUND OF THE INVENTION

1. Field of the Invention

The present invention relates to soy phytochemical composition obtained from soy molasses.

2. Background of the Invention

Soy molasses, as hereinafter is referred to, is a commonly accepted terminology assigned by Chajuss in 1963 to aqueous alcohol soy solubles extract essentially made according to Israel Patent No. 19,168 to Chajuss. Soy molasses is manufactured by an aqueous alcohol extraction of preferably defatted soybean material with a warm aqueous alcohol according to Israel Patent No. 19,168. The alcohols used in the extraction are ethanol, methanol or isopropanol. Thereafter the alcohol and some of the water, as is desired, are removed by such methods as evaporation, distillation and steam stripping to obtain essentially alcohol free, soy molasses with desired moisture content. The usual soy molasses is composed of soy sugars and soy phytochemical nutraceutical components. Soy sugars are the major constituents of the soy molasses and include oligosaccharides (stacchyose and raffinose), disaccharides (sucrose) and small amount of monosaccharides (mainly glucose).

Chajuss in Israel Patent No. 115,110 and in U.S. Pat. No. 5,871,743 teaches novel uses for soy molasses as a source of phytochemicals for prevention and amelioration of diverse and variant pathological conditions. The soy molasses phytochemical nutraceuticals being such soy components as the phytoestrogenes isoflavones (genistein, daidzein and glycitein in their aglycone, glycosides and conjugated forms), saponins, phytosterols, phytates, the Bowman-Birk trypsin and chymotrypsin inhibitor (BBI), phospholipids, phenolic acids, etc. Soy molasses can consequently be considered as a composite source of soybean phytochemical components that are beneficial for prevention and amelioration of various pathological conditions.

Conversely, although soy molasses includes almost the complete array of the various soy phytochemicals, the total amount of the active soy phytochemicals in soy molasses is relatively low. A large amount of soy molasses is thus required to obtain sufficient biologically effective quantities of soy phytochemicals.

TABLE I
TYPICAL ANALYSIS OF SOY MOLASSES ON A
DRY MATTER BASIS

| | |
|---|---|
| Soy Sugars | 58-65% |
| Oligosaccharides (stacchyose and raffinose) | ˜28% |
| Other sugars (mainly sucrose) | ˜32% |
| Crude Protein [N × 6.25] (including amino acids, | 5-7% |
| peptides, etc.) | |
| Crude Lipid Material (Including phosphotides and | 4-7% |
| phytosterols) | |
| Minerals (Ash) | 7-10% |
| Saponins | 6-10% |
| Typical Isoflavones content | 0.8-2% |
| Other organic phytochemical constituents | To 100% |
| (Including phenolic-acids, leucoanthocyanins, | |
| phytates, etc.) | |

Soy molasses is used as a starting raw material to manufacture soy isoflavones. Naim in 1974 first characterized soy isoflavones in soy molasses, made by Chajuss according to Israel Patent No. 19,168, having found a new isoflavone; Naim named glycitein, in soy molasses (Naim, Michael, Ph.D. Thesis, Isolation, characterization and biological activity of soybean isoflavones, The Hebrew University of Jerusalem, Faculty of Agriculture, Rehovot, Israel, 1974). Various patents were issued to cover manufacturing processes of soy isoflavones from soy molasses such as for example U.S. Pat. Nos.: 5,702,752, 5,792,503, 5,821,361, 5,919,921, 5,990,291, 6,033,714 and 6,083,553.

A modified soy molasses product with reduced soy sugars content is obtainable according to Israel Patent No. 119,107 by a partial or a complete removal of sugars from the soy molasses. The removal of the sugars present in the soy molasses is accomplished by such methods as microbial fermentation, treatment with various enzymes and chemical hydrolyzing agents, various physical and chemical procedures, including diverse membrane separation technologies, gel filtration; column separation systems; acid precipitation and/or other systems that precipitate the major non-sugar components of the soy molasses, and removal of the soluble components, mainly the sugars by centrifugation, settling or decantation; and by physical methods in general that can separate and remove sugars from the soy molasses.

The present invention is based on our discovery over the teachings of Israel Patent No. 119,107 that a novel and very unique precipitating sediment can be obtained when soy molasses is treated at certain defined and controlled processing parameters, within a limited range of pH. The unique precipitating sediment obtained by using processing parameters as detailed below contains a relatively large amount of soy phytochemicals components; saponins, isoflavones and low molecular weight heat resistant and stable proteins such as the BBI.

Settling, decantation and/or centrifugation out of the soluble components under defined acidified conditions accomplish removal of the soluble components from the precipitating sedimented components. The precipitating sediment having essentially a unique low cost soy phytochemicals composition that contains an exceptional high amount of soy phytochemicals rich with saponins, isoflavones and low molecular weight protein material.

There are numerous publications related to the importance of soy isoflavones, saponins and certain law molecular weight heat resistant and stable soy proteins such as the BBI. (For example: Tham D M, et al. Clinical Review 97: Potential health benefits of dietary phytoestrogens: a review of the clinical, epidemiological, and mechanistic evidence. J. Cline Endocrinol Metab 1998 Jul; 83(7): 2223-35. Messina M J, et al. Nutr Cancer 21:113, 1994. Bingham, S A, et al. Br J Nutr 1998 May; 79(5): 393-406. Peterson G, Barnes S. Biochem Biophys Res Comm 179:661, 1991. Messina, M., et al. The Simple soybean and Your Health, Avery Press, New York, N.Y., 1994. Barnes s. Breast Cancer Res Treat 1997 Nov-Dec; 46(2-3); 169-79. Roa A and Sumg M. J Nutr 125:771-724, 1995. Messadi D. et al. JNCI 76:447-452, 1986).

### SUMMARY OF THE INVENTION

The present invention provides a novel and unique phytochemical composition made out of soy molasses that comprises of relatively large amount of saponins, isoflavones and low molecular weight protein components by a simple technology and at low cost.

### DETAILED DESCRIPTION OF THE INVENTION

The present invention applies to a phytochemical composition obtained out of soy molasses. The phytochemical composition comprises of substantially larger amount of certain soy phytochemical components: the saponins, isoflavones and low molecular weight protein components including the Bowman Birk Inhibitors, from those found in soy molasses or modified soy molasses, wherein only the soy molasses is done preferably at elevated temperatures such as is in the last evaporation stage of the alcohol out of the soy molasses miscella. Preferably not less than 60 degrees C. and not more than 95 degrees C. to obtain a precipitated residue containing not less than 6% of isoflavones, 18% of saponins and 13% of crude low molecular weight protein material on a dry matter basis.

The acid that should be used in accomplishing the said phytochemical composition can be any food grade acid suitable for human consumption, preferably mineral acid such as hydrochloric acid, phosphoric acid or sulphuric acid. The desired pH range to be obtained should be between the pH of 1.3 to pH of 4.0 and preferably between the pH of 2.0 to pH 3.0. When a strong mineral acid such as sulphuric acid is used it is preferred to use a diluted acid to prevent sizzling and over heating of the suspended acidified soy molasses.

Settling at ambient room temperature, decantation and/or centrifugation can accomplish the removal and separation of the precipitated sediment residue from the soluble components. It is preferred to re-dispersed and wash the precipitated sediment residue before the centrifuged step.

The precipitated sedimented residue after centrifugation should preferably now be dried without overheating and scorching of the obtained material by any suitable drying system that effects mild drying treatment to obtain a dried modified soy molasses phytochemical composition with preferably final moisture content of about 6% to 7%. Such method as lyophilization, air whirl mill drying, spray drying, foam-mat drying, vacuum oven drying, et cetera, can advantageously be employed.

Due to its high content of soy isoflavones, saponins and low molecular weight protein components, the dried modified soy molasses phytochemical composition can thus be used as a dietetic food supplement, as a nutraceutical material and/or as a source of the above-mentioned particular components for further processing and concentration.

The present invention is illustrated by the following nonlimiting example.

### EXAMPLE

Fresh hot soy molasses with moisture content of 50%, made according to Israel Patent No. 19,168, having 60% total sugars, 6% crude protein, 5% crude Lipid material, 8% minerals, 7% saponins and 0.9% isoflavones on a dry matter basis was acidified with diluted sulphuric acid to pH of 2.7. The acidified material was allowed to cool to room temperature, settled overnight and decanted. Then it was re-dispersed, washed and centrifuged in a basket centrifuge to obtain precipitating sediment. The sediment was lyophilized and a modified soy molasses phytochemical composition material was obtained containing 10% total sugars, 16% crude protein, 8% crude Lipid material, 4% minerals, 22% saponins and 6.4% isoflavones on a dry matter basis.

What is claimed is:

1. A soy phytochemical composition obtained by removing soluble components out of acidified soy molasses by settling, decantation and/or centrifugation to obtain a precipitated residue sediment containing not less than 6% of isoflavones, 18% of saponins and 13% of crude low molecular weight protein material on a dry matter basis.

2. A soy phytochemical composition according to claim 1 wherein the pH of the acidified soy molasses is between the pH of 1.3 and 4.0.

3. A soy phytochemical composition according to claim 2 wherein the pH of the acidified soy molasses is between the pH of 2.0 and 3.0.

4. A soy phytochemical composition according to claims 1, 2 and 3 wherein the acid used to acidify the soy molasses is a food grade acid suitable for human consumption.

5. A soy phytochemical composition according to claim 4 wherein the acid used is a mineral acid such as hydrochloric acid, phosphoric acid or sulphuric acid.

6. A soy phytochemical composition according to claim 1 wherein settling, decantation and/or centrifugation is made at ambient room temperature to accomplish the removal and separation of the precipitated residue that comprises the modified soy molasses phytochemical composition from the soluble components.

7. A soy phytochemical composition according to claim 6 wherein the precipitated residue is re-dispersed and washed after the settling and the decantation and prior to the centrifugation.

8. A soy phytochemical composition according to any of the preceding claims wherein the precipitated residue that comprises the soy phytochemical composition is dried to obtain a dried soy phytochemical composition.

9. A soy phytochemical composition according to claim 8 wherein the drying is accomplished by lyophilization, air whirl-mill drying, spray drying foam-mat drying and/or vacuum oven drying.

10. A soy photochemical composition made essentially according to any of the preceding claims, for use as a dietetic food supplement, as a nutraceutical material and/or as a source of soy phytochemicals for further processing and concentration.
